(19) United States
(12) Patent Application Publication
(10) Pub. No.: US 2020/0146921 A1
(43) Pub. Date: May 14, 2020

(54) METHOD OF MAKING PILLOW FOR CASKET

(71) Applicant: Vandor Corporation, Richmond, IN (US)

(72) Inventors: Justin F. Davis, Richmond, IN (US); Gerald H. Davis, Fountain City, IN (US)

(21) Appl. No.: 16/190,550

(22) Filed: Nov. 14, 2018

(51) Int. Cl. A61G 17/04; A61G 17/007; A47G 9/10

(52) U.S. Cl. CPC A61G 17/044; A47G 9/10; A61G 17/007

(57) ABSTRACT

A method of making a pillow for use in a casket includes sewing a pillowcase having a main body portion and a narrowed portion such that the main body portion is closed along a perimeter except at the narrowed portion, and such that the narrowed portion projects from the perimeter, and such that the narrowed portion is open on two ends. The method further includes passing material through the two open ends of the narrowed portion into the main body portion. The method further includes folding fabric of the narrowed portion inwardly into the main body portion.

### FIELD OF THE INVENTION

This invention relates to pillows for use in caskets, and more specifically to casket pillows which are easily and inexpensively made.

### BACKGROUND

As shown in FIG. 1, a casket arrangement 10 typically includes a casket pillow 14 to lay the head of the deceased upon for display during ceremonies and services. It is desirable for the casket pillow to look substantially similar to a typical bed pillow so that the deceased arranged upon the pillow has the appearance of resting peacefully in the casket. Accordingly, it is desirable for casket pillows to appear soft, supportive, and tidy while providing the appropriate amount of compression and loft for display. However, because casket pillows do not need to be comfortable, it is also desirable for pillows used in caskets to be made in a manner that reduces costs.

One source of costs associated with making casket pillows is the required labor. For example, forming the pillowcase for the pillow requires labor. The pillowcase must be sewn or otherwise formed from at least one panel of fabric material so that the pillowcase can be filled with filling material. Additionally, then, filling the pillowcase with filling material requires additional labor. Furthermore, once the pillowcase has been filled with the filling material, the pillowcase must be closed to retain the filling material within the pillowcase during subsequent transportation and use of the pillow. Closing the pillowcase further provides the desired appearance of the finished pillow within the casket. Closing the pillowcase requires still more labor. Each of these steps is necessary for providing a pillow for use in a casket. Accordingly, one way to reduce costs associated with the labor for performing each of these steps is to improve the ease and efficiency of each of these steps.

Another source of costs associated with making casket pillows is the required materials. For example, pillows require fabric material and thread for forming a pillowcase, filling material for filling the pillowcase, and some closing element for closing the filled pillowcase. Use of each of these materials inherently generates some waste. Accordingly, one way to reduce costs associated with the materials for making casket pillows is to improve the efficiency of use of the materials.

### SUMMARY

One or more embodiments of the present disclosure provides a method of making a pillow for use in a casket. The method includes sewing a pillowcase having a main body portion and a narrowed portion such that the main body portion is closed along a perimeter except at the narrowed portion, such that the narrowed portion projects from the perimeter, and such that the narrowed portion is open on two ends. The method further includes passing material through the two open ends of the narrowed portion into the main body portion. The method further includes folding fabric of the narrowed portion inwardly into the main body portion.

At least one embodiment of the present disclosure provides a method of making a pillow for use in a casket. The method includes arranging two panels of fabric on a frame in an operating area of a programmable sewing machine. The method further includes operating the programmable sewing machine to sew the two panels of fabric together along a stitching path to form a pillowcase having a main body portion and a narrowed portion. The method further includes removing the pillowcase from the frame, inverting the pillowcase such that the stitching path is arranged in an interior of the pillowcase, filling the interior of the pillowcase with a material, and tucking the narrowed portion into the main body portion.

The above-described features and advantages, as well as others, will become more readily apparent to those of ordinary skill in the art by reference to the following detailed description and accompanying drawings.

### BRIEF DESCRIPTION OF THE DRAWINGS

FIG. 1 depicts a casket arrangement including a casket pillow.

FIG. 2 depicts a flowchart of a method of making a pillow for use in a casket arrangement.

FIG. 3 depicts a schematic drawing of a frame and a sewing machine to be used in one embodiment of the method of FIG. 2 to sew layers of fabric together to make a pillowcase for the pillow.

FIG. 4 depicts the layers of fabric of FIG. 3 sewn together along a stitching path to form a main body portion and a narrowed portion.

FIG. 5 depicts a schematic drawing of the stitching path of FIG. 4.

FIG. 6 depicts the sewn together layers of fabric of FIG. 4 removed from the frame.

FIG. 7 depicts the sewn together layers of fabric of FIG. 6 after the layers of fabric have been trimmed to remove excess material.

FIG. 8 depicts the layers of fabric of FIG. 7 after the layers of fabric have been inverted to form a pillowcase.

FIG. 9 depicts a schematic drawing of the pillowcase of FIG. 8 and filling material to be inserted into the pillowcase.

FIG. 10 depicts a schematic drawing of the filling material of FIG. 9 within a main body portion of the pillowcase of FIG. 8.

FIG. 11 depicts a schematic drawing of the filling material of FIG. 9 and a narrowed portion of the pillowcase of FIG. 8 arranged within the main body portion of the pillowcase of FIG. 8.

### DETAILED DESCRIPTION

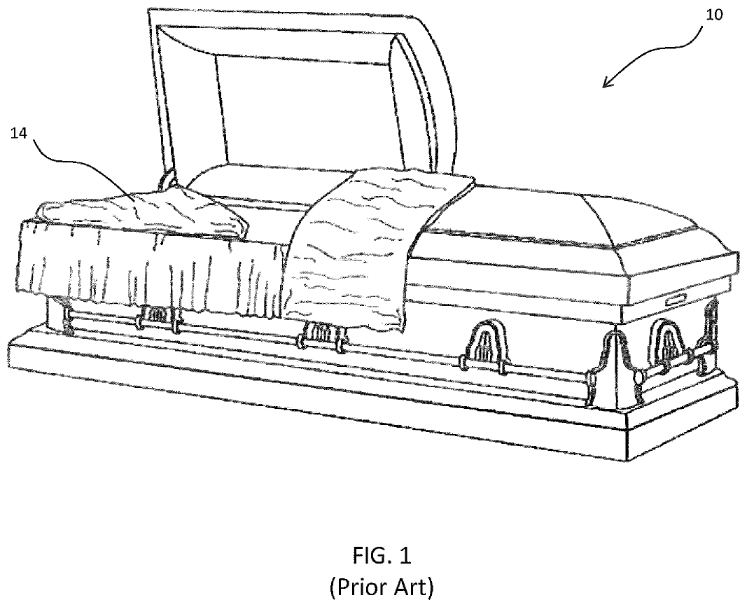

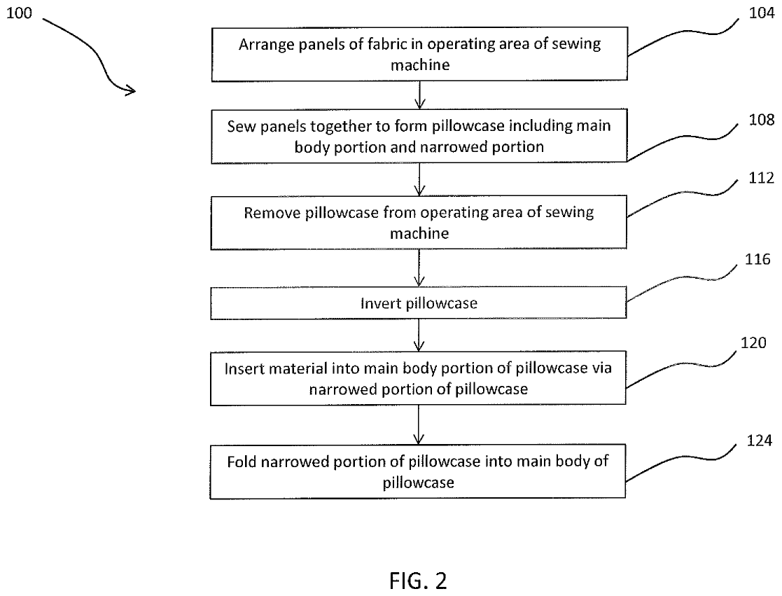

FIG. 2 depicts a flowchart of a method 100 of making a pillow for use in a casket arrangement, such as the pillow 14 shown in the casket arrangement 10 of FIG. 1. As described in further detail below, the method 100 includes arranging panels of fabric in an operating area of a sewing machine (block 104). The method 100 further includes sewing the panels together to form a pillowcase including a main body portion and a narrowed portion (block 108). The method 100 further includes removing the pillowcase from the operating area of the sewing machine (block 112), inverting the pillowcase (block 116), and inserting filling material into the main body portion of the pillowcase via the narrowed portion of the pillowcase (block 120). The method 100 also includes folding the narrowed portion of the pillowcase into the main body portion of the pillowcase (block 124) to complete the pillow.

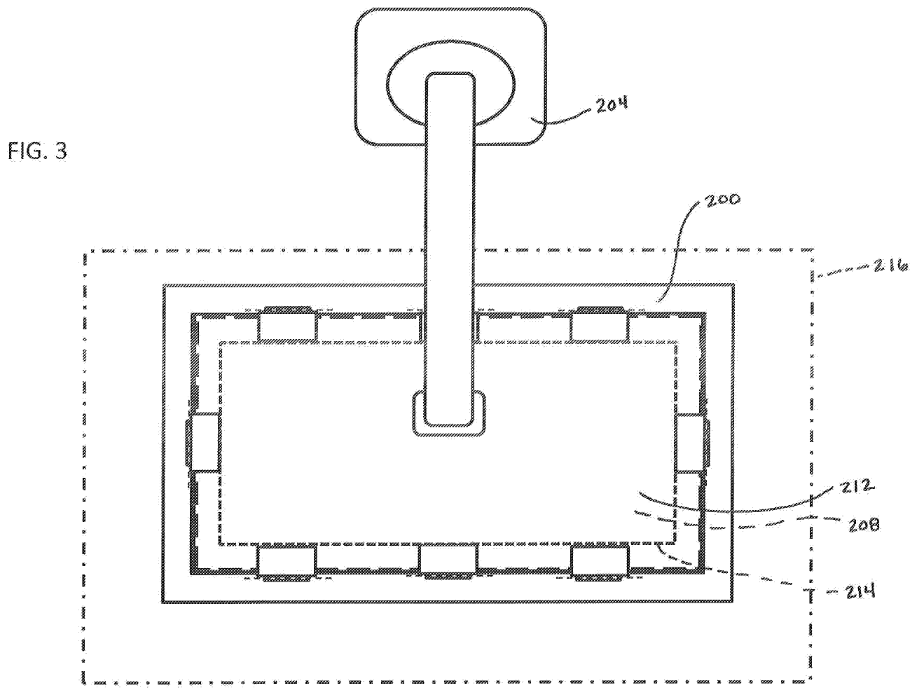

FIG. 3 depicts a schematic drawing of a frame 200 to be used in arranging panels of fabric 208, 212 in the operating area 216 of a sewing machine 204 (see block 104 of method 100). FIG. 3 also depicts a schematic drawing of the sewing machine 204 to be used in sewing the panels of fabric 208, 212 together to form a pillowcase (see block 108 of method 100). As shown in FIG. 3, a first panel of fabric 208 is arranged beneath a second panel of fabric 212 for the sewing process in a manner that is typical in sewing processes. (The first panel of fabric 208 is represented by dashed lines in FIG. 3 to indicate its position beneath the second panel of fabric 212.) The first and second panels of fabric 208, 212 are furthermore arranged on the frame 200 so as to cover an opening 214 in the frame 200. (The opening 214 is represented by dashed lines in FIG. 3 to indicate its position beneath the first and second panels of fabric 208, 212.)

Once the first and second panels of fabric 208, 212 are arranged on the frame 200, the frame 200 is arranged in the operating area 216 of the sewing machine 204. In particular, the frame 200 is arranged relative to the sewing machine 204 such that the opening 214 is arranged in the operating area 216 of the sewing machine 204. The frame 200 holds the first and second panels 208, 212 in place relative to each other and relative to the frame 200 during the sewing operation performed in the operating area 216 by the sewing machine 204.

In an alternative embodiment, more than two panels of fabric can be arranged on the frame 200 and sewn together by the sewing machine 204 to produce a desired aesthetic. For example, a panel of fabric made of a particularly thin material may have a surface texture and/or appearance which is desired for viewing in the casket arrangement. However, the thin material may be too sheer or translucent to use on its own as the panel of fabric that makes up the visible side of the pillowcase. In other words, using the thin material as one of the panels of fabric that makes up the pillowcase may result in undesirable visibility of less aesthetically desirable filling material within the pillow. Accordingly, an additional panel of fabric may be sewn to the panel of thin material to provide adequate opacity to the visible side of the pillowcase while still enabling the panel of thin material to be arranged on the exterior of the pillow for viewing in the casket arrangement.

In another alternative embodiment, the panels of fabric can, in fact, be a single continuous piece of fabric that is doubled or folded onto itself prior to sewing. In such an embodiment, the single continuous piece of fabric provides both of the two panels of fabric to be sewn together. In any case, the method 100 includes arranging at least two panels of fabric, such as first panel 208 and second panel 212, on the frame 200 in an operating area 216 of the sewing machine 204 (see block 104 of method 100).

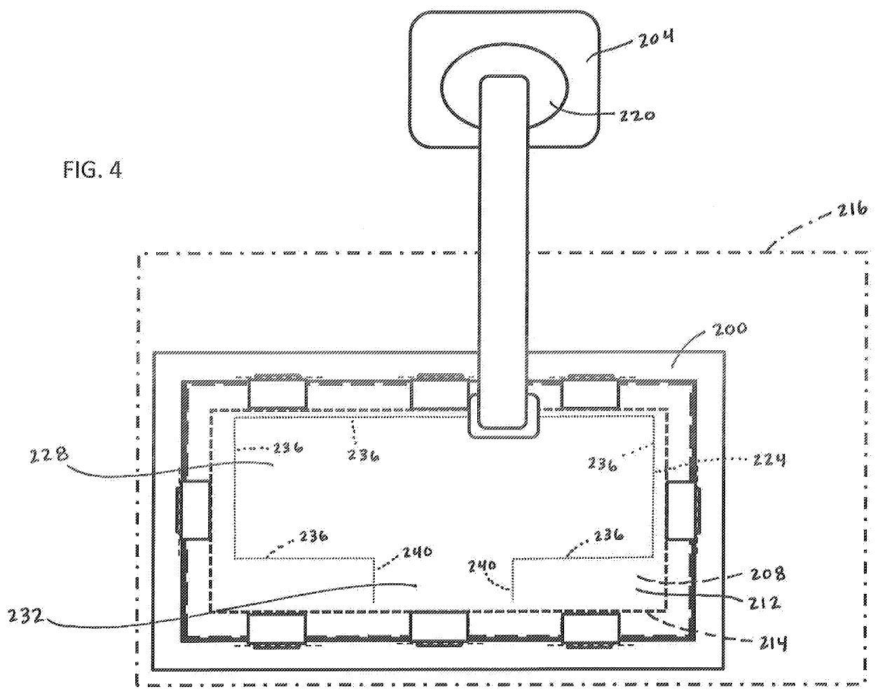

Once the panels of fabric 208, 212 have been arranged on the frame 200 in the operating area 216, the sewing machine 204 is operated to sew the first and second panels of fabric 208, 212 together to form a pillowcase (see block 108 of method 100). In the embodiment shown, the sewing machine 204 is a programmable sewing machine. Accordingly, as shown in FIG. 4, sewing the panels of fabric 208, 212 together with the programmable sewing machine 204 includes operating the programmable sewing machine 204 with a controller 220 (not shown or described in greater detail) to execute a program of sewing operations to sew the panels of fabric 208, 212 together along a stitching path 224 within the opening 214 of the frame 200. In FIG. 4, the stitching path 224 is shown as having been completed, and is represented by a dotted line. The stitching path 224 includes main body portion lines of stitches 236 that form a main body portion 228 of the pillowcase and narrowed portion lines of stitches 240 that form a narrowed portion 232 of the pillowcase.

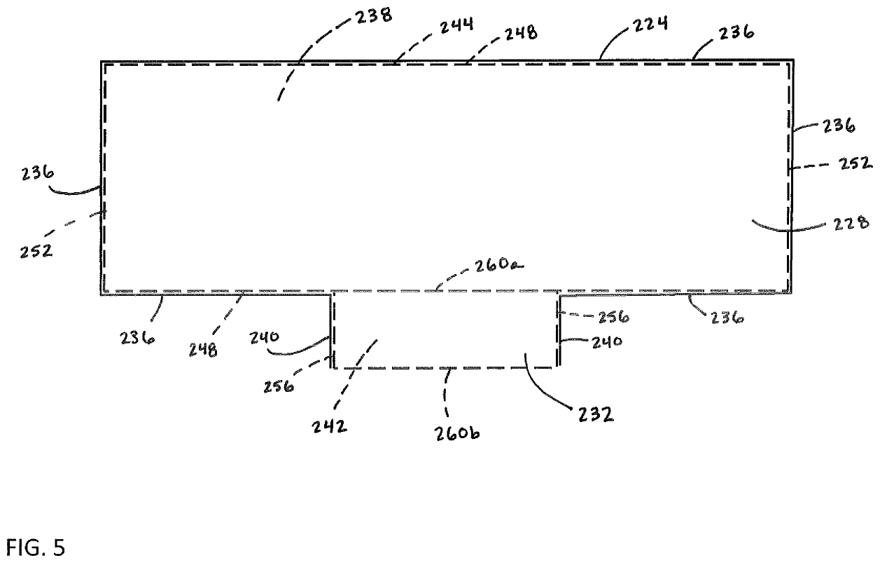

FIG. 5 shows a schematic drawing of the stitching path 224 including the main body portion lines of stitches 236, which form the main body portion 228, and narrowed portion lines of stitches 240, which form the narrowed portion 232. In FIG. 5, the lines of stitches 236, 240 are represented by solid lines. The main body portion lines of stitches 236 generally form a rectangle 238, which is represented by dashed lines in FIG. 5. The rectangle 238 has a perimeter 244 with two long sides 248 and two short sides 252. The main body portion 228 is closed along the perimeter 244 except where it extends along the narrowed portion 232. In other words, the main body portion 228 formed by the main body portion lines of stitches 236 is not completely closed, but is open along the perimeter 244 where the main body portion 228 coextends with the narrowed portion 232. Accordingly, as further described below, the main body portion 228 is closed along the perimeter 244 except at an opening that is formed by the narrowed portion 232.

The narrowed portion lines of stitches 240 generally form a rectangle 242, which is represented by dashed lines in FIG. 5. The rectangle 242 extends outwardly from one of the long sides 248 of the perimeter 244 of the rectangle 238. More specifically, the narrowed portion lines of stitches 240 form two opposite sides 256 of the rectangle 242, and the other two sides 260a, 260b of the rectangle 242 are not closed by narrowed portion lines of stitches 240. Thus, the other two sides 260a, 260b of the rectangle 242 are open. The open sides 260a, 260b of the rectangle 242 are also referred to herein as a first open end 260a and a second open end 260b of the narrowed portion 232. The first open end 260a is formed between the narrowed portion lines of stitches 240, and is coextensive with the opening in the perimeter 244 where the narrowed portion 232 meets the main body portion 228. Put another way, the opening in the perimeter 244 of the rectangle 238 is coextensive with the first open end 260a. Accordingly, the second open end 260b of the narrowed portion 232 is formed between the narrowed portion lines of stitches 240, and is arranged opposite the opening in the perimeter 244. Thus, the narrowed portion 232 is open on the first and second open ends 260a, 260b and thereby provides access to the interior of the main body portion 228 via the opening in the perimeter 244.

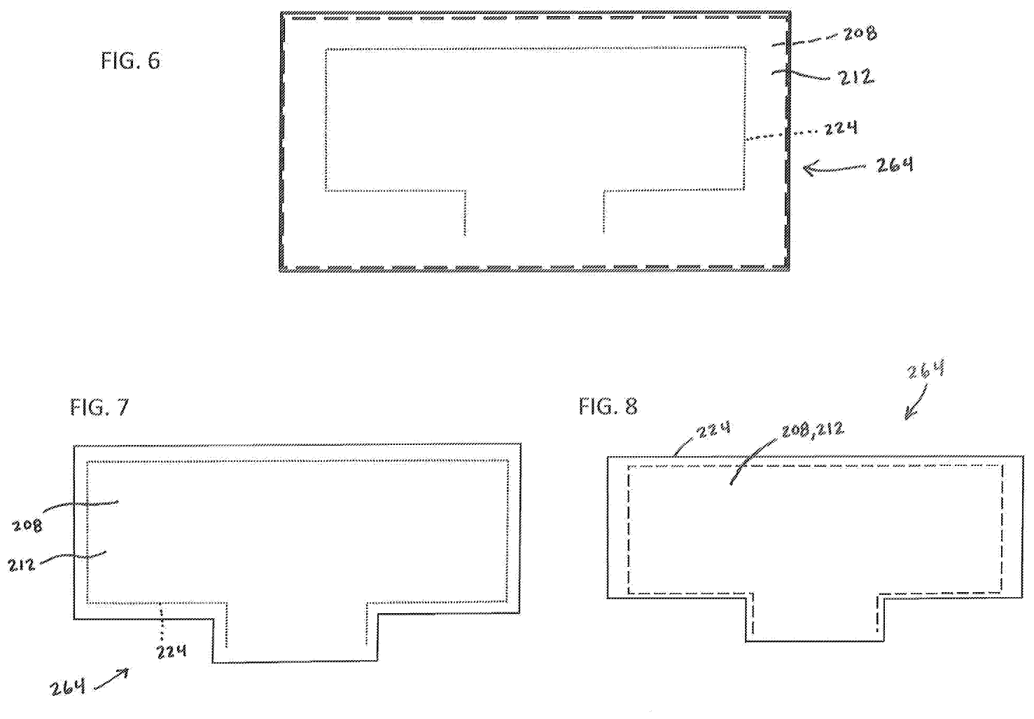

As shown in FIG. 6, once the panels of fabric 208, 212 have been sewn together by the sewing machine 204 (shown in FIG. 3), the frame 200 (shown in FIG. 3) is removed from the operating area 216 (shown in FIG. 3) of the sewing machine 204 and the panels of fabric 208, 212, which now make up the pillowcase 264, are removed from the frame 200 (see block 112 of method 100). In an alternative embodiment, the panels of fabric 208, 212 can be sewn together by a traditional (non-programmable) sewing machine rather than a programmable sewing machine. In such an embodiment, the panels of fabric 208, 212 need not be arranged on a frame prior to being arranged in the operating area of the sewing machine. As logically follows, the resulting pillowcase 264 also will not be removed from a frame. Accordingly, in such an alternative embodiment, removing the pillowcase 264 from the operating area of the sewing machine does not include removing the pillowcase from the frame.

In another alternative embodiment, the panels of fabric 208, 212 can be sewn together by hand. In such an embodiment, the panels of fabric 208, 212 are arranged in an operating area of a person sewing the panels together by hand rather than an operating area of a sewing machine. Similarly, in such an embodiment, the sewn pillowcase 264 is removed from the operating area of the person who sewed the panels of fabric together by hand rather than an operating area of a sewing machine.

One advantage of sewing the panels of fabric 208, 212 together using the programmable sewing machine 204 is a reduction in labor costs. A programmable sewing machine is capable of sewing more quickly with fewer errors than a human seamstress, which reduces the amount of time required to sew each pillowcase. While the programmable sewing machine may still be operated by a human, the efficiency of the use of labor is still improved as the programmable sewing machine enables the human to produce more pillowcases in the same amount of time. Additionally, operating the programmable sewing machine requires a lower amount of skill and experience than sewing by hand. Accordingly, the labor that is used to produce the pillowcase using a programmable sewing machine can be less skilled, and thus less expensive, than the labor that is used to produce the pillowcase by a traditional (non-programmable) sewing machine. Thus, using a programmable sewing machine reduces labor costs associated with sewing pillowcases.

Another advantage of using the programmable sewing machine 204 to sew the panels of fabric 208, 212 together is a reduction in material costs. A programmable sewing machine is less likely to make an error than a human seamstress, which results in less wasted materials. Additionally, a programmable sewing machine can be programmed to optimize material usage, for example, by sewing stitching lines closer together than is practical for a human seamstress, who will require greater seam allowances. Furthermore, a programmable sewing machine will produce a completely standardized product, while products produced by human seamstresses will have some inherent variation. Given the intended use of the pillowcase, to present as tidy an appearance in a casket as possible, it is desirable to produce pillowcases that consistently fit in a casket the same way, therefore having consistent dimensions. Accordingly, using a programmable sewing machine reduces material costs associated with sewing pillowcases and improves the consistency of the product.

As shown in FIG. 7, once the panels of fabric 208, 212 have been sewn together along the stitching path 224 (see block 108 of method 100) and the resulting pillowcase 264 has been removed from the operating area of the sewing machine (see block 112 of method 100), excess fabric is trimmed from the panels of fabric 208, 212 to produce a uniform hem. In FIG. 7, the edges of the panels of fabric 208, 212, and thus the edges of the pillowcase 264, are represented by a solid line, and the stitching path 224 is represented by a dotted line. The hem is that portion of the panels of fabric 208, 212 between the edges of the panels of fabric and the stitching path 224.

As shown in FIG. 8, the trimmed pillowcase 264 is then inverted over the stitching path 224 (see block 116 of method 100). In other words, the pillowcase 264 is turned inside-out (or “right-side-out”) such that the seam formed by the stitching path 224 forms the outermost edge of the pillowcase 264. Accordingly, in FIG. 8, the seam provided by the stitching path 224, and thus the edge of the pillowcase 264, is represented by a solid line. The edges of the panels of fabric 208, 212 are represented by dashed lines to indicate that they are arranged inside the pillowcase 264. Inverting the pillowcase 264 is advantageous because arranging the seam formed by the stitching path 224 to form the outermost edge of the pillowcase 264 provides the pillowcase 264 with a tidy, consistent appearance.

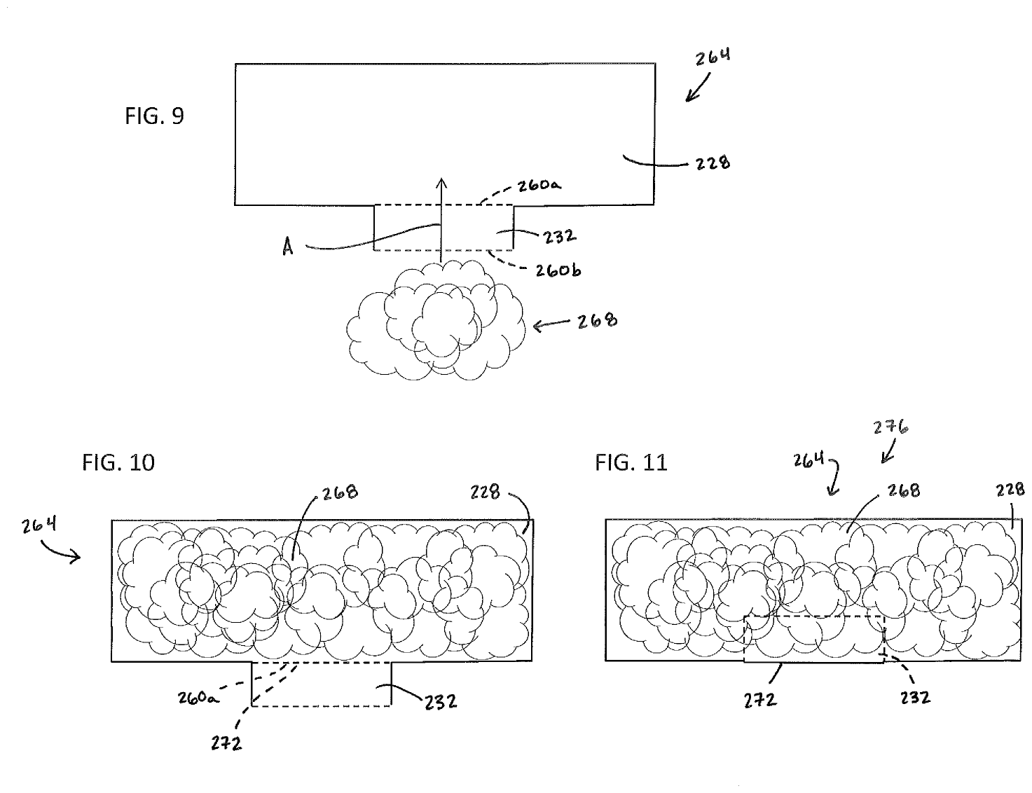

As shown in FIG. 9, once the pillowcase 264 has been inverted, it is filled with filling material 268 (see block 120 of method 100) by passing the filling material 268 through the first and second open ends 260a, 260b of the narrowed portion 232 into the interior of the main body portion 228 as indicated by the arrow A. (In FIG. 9, the first and second open ends 260a, 260b of the narrowed portion 232 are represented by dashed lines.) The filling material 268 can be, for example, loose fiber batting. Alternatively, the filling material 268 can be another material which will fill the interior of the main body portion 228 of the pillowcase 264. The filling material 268 is any material which is suitable for filling a pillow. In a preferred embodiment, the filling material 268 is one which can be moved easily into the corners of the main body portion 228 to provide a consistently filled pillow, which contributes to the tidy appearance of the pillow in use in the casket. Additionally, the filling material 268 is also one which will enable the pillow to compress substantially evenly under the weight of the head and neck of the deceased, which also contributes to the tidy appearance of the pillow in use in the casket.

More specifically, inserting the filling material 268 into the main body portion 228 further includes fitting the second open end 260b of the narrowed portion 232 over an output of a pillow blower, or pillow filling machine, to enable the pillow filling machine to move the filling material 268 through the first and second open ends 260a, 260b of the narrowed portion 232 and into the main body portion 228 of the pillowcase 264. A pillow filling machine is configured to mechanically move filling material from a source through an output by use of pressurized air. Accordingly, the pillowcase 264 is configured such that the second open end 260b of the narrowed portion 232 can be readily fitted over the output of a pillow filling machine. Additionally, the filling material 268 is one which can be inserted into the pillowcase 264 by a pillow filling machine, to enable automated filling of the pillowcase 264 with the filling material 268.

In an alternative embodiment, the pillowcase 264 can be filled by hand by removing filling material 268 from a source and inserting the filling material 268 through the first and second open ends 260a, 260b of the narrowed portion 232 into the main body portion 228. However, using a pillow filling machine to fill the pillowcase 264 reduces labor and material costs associated with making a pillow relative to filling the pillowcase by hand.

Pillow filling machines are able to insert filling material into pillowcases faster and more consistently than a human inserting filling material into pillowcases by hand. Accordingly, pillow filling machines reduce labor costs by enabling a human to fill more pillowcases in the same amount of time. Additionally, pillow filling machines move filling material directly from the source into the pillowcase via an opening in the pillowcase. In contrast, a human filling a pillowcase by hand removes filling material from the source and then inserts it through an opening into the pillowcase, inherently losing some amount of filling material from their hand between the source and the pillowcase. Accordingly, pillow filling machines also reduce material costs by enabling a human to waste less filling material while filling a pillowcase. Even if the pillow filling machine is operated by a human, the labor and material costs associated with filling a pillow will be reduced relative to filling a pillow by hand.

As shown in FIG. 10, the filling material 268 is inserted into the pillowcase 264 so as to fill the main body portion 228 but not the narrowed portion 232. Once the main body portion 228 has been filled with the filling material 268, the narrowed portion 232 is folded inwardly into the main body portion 228 (see block 124 of method 100). Put another way, the narrowed portion 232 is tucked into the main body portion 228. In particular, the portions of the fabric of the pillowcase 264 that make up the narrowed portion 232 are folded through the first open end 260a of the narrowed portion 232. Accordingly, the fabric of the narrowed portion 232 is folded along a fold line 272 that is coincident with the first open end 260a of the narrowed portion 232, and is thus coincident with the opening in the perimeter 244 (shown in FIG. 5). In other words, the fold line 272 extends from the closed side 256 of the rectangle 242 on one side of the narrowed portion 232 (shown in FIG. 5) to the closed side 256 of the rectangle 242 on the other side of the narrowed portion 232. Thus, the fold line 272 is arranged along the perimeter 244 of rectangle 238 of the main body portion 228 (shown in FIG. 5), and the first open end 260a of the narrowed portion 232 is arranged along the fold line 272.

As used herein, folding the narrowed portion 232 “at” a particular feature also means folding the narrowed portion “over” that particular feature or “along” that particular feature. For example, folding the narrowed portion 232 “along” the fold line 272 also means that the narrowed portion 232 is folded “over” the fold line 272 and that the narrowed portion 232 is folded “at” the fold line 272. These three terms are used interchangeably herein to indicate that an element at, along, or over which the narrowed portion 232 is folded provides a point of reference relative to which the narrowed portion 232 is folded such that the narrowed portion 232 is arranged on the opposite side of the element after folding. For example, folding at, along, or over an element can result in arrangement of the narrowed portion 232 in a substantially mirrored position on the opposite side of the element.

As shown in FIG. 11, folding the narrowed portion 232 into the main body portion 228, as described above, arranges all of the fabric of the narrowed portion 232 inside the main body portion 228 to complete a pillow 276, which can be used, for example, as the casket pillow 14 shown in the casket arrangement 10 of FIG. 1. (In FIG. 11, the narrowed portion 232 is represented by dashed lines to indicate its position inside the main body portion 228.) Accordingly, the fold line 272 forms the edge of the pillow 276 at the opening in the perimeter 244 (shown in FIG. 5) of the pillowcase 264. Thus, in FIG. 11, the fold line 272 is represented by a solid line. The narrowed portion 232 is folded into the main body portion 228 in such a manner that the edge of the pillowcase 264 generally appears to be continuous, despite the opening in the perimeter 244 at the first open end 260a of the narrowed portion 232. This contributes to the tidy appearance of the pillow 276.

Furthermore, the narrowed portion 232 is folded into the main body portion 228 in such a manner so as to retain the filling material 268 within the main body portion 228 during subsequent transportation and use of the pillow 276. Further to this end, the lengths of the closed sides 256 of the narrowed portion 232 (shown in FIG. 5), are long enough to enable the narrowed portion 232 to retain the filling material 268 within the main body portion 228. For example, the lengths of the closed sides 256 of the narrowed portion 232 are larger than the length of the hem formed between the main body portion lines of stitches 236 (shown in FIG. 5) and the trimmed edges of the panels of fabric 208, 212 (shown in FIG. 7). Accordingly, as described herein, the narrowed portion 232 projects from the main body portion 228, and this projection of the narrowed portion 232 provides enough fabric material to generate sufficient friction to retain the filling material 268 within the main body portion 228 when the narrowed portion 232 has been folded into the main body portion 228.

As shown in FIG. 10, the pillowcase 264 is formed such that the narrowed portion 232 extends from the approximate center of one of the long sides 248 of the perimeter 244 (shown in FIG. 5). Accordingly, the narrowed portion 232 extends from the approximate center of one of the long sides of the main body portion 228. This arrangement is advantageous because when the pillow 276 (shown in FIG. 11) is arranged in the casket and the deceased is arranged on the pillow 276, the narrowed portion 232 can be arranged beneath the head and/or neck of the deceased. This arrangement will cover the portion of the edge of the pillowcase 264 that is not actually continuous as it is interrupted by the opening in the perimeter 244. Accordingly, this arrangement further enables a tidy, consistent appearance of the pillow 276 by covering the non-continuous edge of the pillowcase 264, which is formed by the first open end 260a of the narrowed portion 232.

Furthermore, covering the non-continuous edge of the pillowcase 264 eliminates the need to close the pillowcase 264 at the first open end 260a, which further reduces labor and materials costs associated with forming the pillow 276. In contrast, to close a casket pillow along the entire edge of the pillowcase 264, a zipper, buttons, snaps, or other closing elements are required to close the opening through which the pillowcase was filled with filling material.

Such closing elements, if visible in the final product, may even detract from the desired aesthetic of a tidy, comfortable pillow Eliminating the need for such closing elements eliminates labor costs of applying such closing elements to the pillow as well as material costs of providing such closing elements.

Additionally, leaving the edge of the pillowcase 264 open at the first open end 260a by folding the narrowed portion 232 into the main body portion 228, rather than closing the pillowcase 264 at the first open end 260a with closing elements, enables the person arranging the deceased on the pillow 276 to easily reach into the pillow 276 to adjust the amount or position of the filling material 268 within the pillowcase 264.

In an alternative embodiment, the main body portion lines of stitches 236 and the narrowed portion lines of stitches 240 can form shapes other than the rectangles 238, 242. For example, one or both of the lines of stitches 236, 240 can generally form ovals, squares, circles, or any other shapes so long as the narrowed portion 232 projects from the main body portion 228 and can be folded over a fold line and tucked into the main body portion 228 in the manner described above.

The present disclosure provides a method for forming a pillow for use in a casket that reduces labor and material costs associated with making casket pillows. Of course, numerous other adaptations are possible. Moreover, there are advantages to individual advancements described herein that may be obtained without incorporating other aspects described above. Therefore, the spirit and scope of the appended claims should not be limited to the description of the preferred embodiments contained herein.

What is claimed is:

1. A method of making a pillow for use in a casket, the method comprising:
sewing a pillowcase having a main body portion and a narrowed portion such that the main body portion is closed along a perimeter except at the narrowed portion, such that the narrowed portion projects from the perimeter, and such that the narrowed portion is open on two ends;
passing material through the two open ends of the narrowed portion into the main body portion;
folding fabric of the narrowed portion inwardly into the main body portion.

2. The method of claim 1, wherein folding fabric of the narrowed portion includes folding the fabric of the narrowed portion through a first open end of the two open ends.

3. The method of claiml, wherein folding fabric of the narrowed portion includes folding the fabric of the narrowed portion at a fold line.

4. The method of claim 3, wherein folding the fabric of the narrowed portion at the fold line includes folding the fabric of the narrowed portion at the perimeter of the main body portion.

5. The method of claim 3, wherein folding the fabric of the narrowed portion at the fold line includes arranging all of the fabric of the narrowed portion within the main body portion.

6. The method of claim 3, wherein folding the fabric of the narrowed portion at the fold line includes folding the fabric of the narrowed portion at the first open end of the narrowed portion.

7. The method of claim 1, wherein:
the perimeter of the main body portion includes two long sides and two short sides, and
the narrowed portion projects from one of the two long sides.

8. The method of claim 1, wherein passing material through the two open ends of the narrowed portion includes fitting a second open end of the two open ends of the narrowed portion over an output of a pillow filling machine.

9. A method of making a pillow for use in a casket, comprising:
arranging two panels of fabric on a frame in an operating area of a programmable sewing machine;
operating the programmable sewing machine to sew the two panels of fabric together along a stitching path to form a pillowcase having a main body portion and a narrowed portion;
removing the pillowcase from the frame;
inverting the pillowcase such that the stitching path is arranged in an interior of the pillowcase;
filling the interior of the pillowcase with a material; and
tucking the narrowed portion into the main body portion.

10. The method of claim 9, wherein operating the programmable sewing machine includes sewing the pillowcase such that the main body portion is closed along a perimeter except at the narrowed portion, such that the narrowed portion projects from the perimeter, and such that the narrowed portion is open on two open ends.

11. The method of claim 10, wherein filling the interior of the pillowcase includes passing the material through the two open ends of the narrowed portion into the main body portion.

12. The method of claim 10, wherein tucking the narrowed portion into the main body portion includes folding the narrowed portion through a first open end of the two open ends.

13. The method of claim 10, wherein tucking the narrowed portion into the main body portion includes folding the narrowed portion at a fold line.

14. The method of claim 13, wherein folding the narrowed portion at the fold line includes folding the narrowed portion at the perimeter of the main body portion.

15. The method of claim 13, wherein folding the narrowed portion at the fold line includes arranging all of the narrowed portion within the main body portion.

16. The method of claim 13, wherein folding the narrowed portion at the fold line includes folding the narrowed portion at a first open end of the two open ends of the narrowed portion.

17. The method of claim 10, wherein:
the perimeter of the main body portion includes two long sides and two short sides, and
the narrowed portion projects from one of the two long sides.

18. The method of claim 10, wherein filling the interior of the pillowcase with material includes fitting a second open end of the two open ends of the narrowed portion over an output of a pillow filling machine before passing the material through the two open ends of the narrowed portion into the main body portion.
